(19) United States
(12) Patent Application Publication
(10) Pub. No.: US 2023/0198084 A1
(43) Pub. Date: Jun. 22, 2023

(54) BATTERY PACK FOR A VEHICLE

(71) Applicants: HYUNDAI MOTOR COMPANY, Seoul (KR); KIA CORPORATION, Seoul (KR)

(72) Inventors: Tae Hyuck Kim, Asan-si (KR); Jae Hyeon Ju, Seoul (KR); Chang Mo Sung, Gunpo-si (KR); Mee Sun Oh, Hwaseong-si (KR); Min Seok Seo, Gimpo-si (KR)

(73) Assignees: HYUNDAI MOTOR COMPANY, Seoul (KR); KIA CORPORATION, Seoul (KR)

(21) Appl. No.: 17/943,290

(22) Filed: Sep. 13, 2022

(30) Foreign Application Priority Data
Dec. 17, 2021 (KR) 10-2021-0181674

(51) Int. Cl. H01M 50/325; B60L 50/64; H01M 50/204; H01M 50/291; H01M 50/262; H01M 50/249

(52) U.S. Cl. CPC H01M 50/325; B60L 50/64; H01M 50/204; H01M 50/249; H01M 50/262; H01M 50/291; H01M 2200/20; H01M 2220/20

(57) ABSTRACT

A battery pack for a vehicle is proposed. The battery pack for a vehicle includes a plurality of battery modules arranged on a flat surface in a battery casing, a plurality of longitudinal members and a plurality of transversal members arranged between the plurality of battery modules, and a venting valve provided at an upper portion of the battery casing and communicating with installation spaces of the plurality of longitudinal members or the plurality of transversal members, and securing a discharge space for gas at an outside space of the battery casing.

### CROSS REFERENCE TO RELATED APPLICATION

This application claims priority to and the benefit of Korean Patent Application No. 10-2021-0181674, filed Dec. 17, 2021, the entire contents of which are incorporated herein by reference.

### BACKGROUND

### Field

The present disclosure relates generally to a battery pack for a vehicle and, more particularly, to a gas discharge technology of a battery pack.

### Description of the Related Art

The statements in this section merely provide background information related to the present disclosure and may not constitute prior art.

In recent electric vehicles, etc., a high voltage battery for supplying power to the vehicle is mounted in the vehicle in the form of a battery pack.

The battery pack accommodates a plurality of battery modules in a battery casing including a lower casing and an upper cover. Each of the battery modules consists of a plurality of battery cells.

As described above, in the battery pack in which a plurality of battery cells are integrated, when a separating membrane of a battery cell is damaged for various reasons, heat generation, off-gas emission, and thermal runaway may occur. When the gas emitted as described above is not quickly and smoothly discharged to the outside space of the battery pack, further damage may be caused by the chain action of other battery cells adjacent to the damaged battery cell.

The foregoing is intended merely to aid in the understanding of the background of the present disclosure and may not fall within the purview of the related art that is already known to those of having ordinary skill in the art.

### SUMMARY

The present disclosure provides a battery pack for a vehicle. In particular, when off gas is generated in a battery pack, the battery pack is configured to quickly and efficiently emit the off gas to reduce or prevent chain of the thermal runaway of battery cells in the battery pack, thereby reducing or minimizing damage to the battery pack in an emergency state.

According to one aspect of the present disclosure, a battery pack for a vehicle includes: a plurality of battery modules arranged on a flat surface in a battery casing; a plurality of longitudinal members and a plurality of transversal members arranged between the plurality of battery modules; and a venting valve provided at an upper portion of the battery casing and communicating with installation spaces formed by the plurality of longitudinal members or the plurality of transversal members, and securing a discharge space for gas at an outside space of the battery casing.

The installation spaces formed by the plurality of longitudinal members and the plurality of transversal members may be arranged to form a grid shape so that the installation spaces may communicate with each other on the flat surface formed by the plurality of battery modules.

The installation spaces of the plurality of longitudinal members and the plurality of transversal members may communicate with each other.

The venting valve may communicate with one installation space among the installation spaces of the plurality of longitudinal members. In one embodiment, the one installation space is extended rearward from the battery casing.

The battery pack may include: a plurality of fixation brackets mounted to a rear end of the battery casing to fix the battery casing to a vehicle body; wherein the venting valve may communicate with one installation space of the installation spaces defined by the plurality of longitudinal members. In one embodiment, the one installation space is extended toward a gap between the fixation brackets.

The plurality of fixation brackets may include two fixation brackets provided at opposite portions of the rear end of the battery casing; and the venting valve may communicate with one installation space of the installation spaces of the plurality of longitudinal members. In one embodiment, the one installation space is extended toward a rear center portion of the battery casing.

The venting valve may be provided at an upper edge of the battery casing.

The venting valve may be configured to maintain a state where an inside space and the outside space of the battery casing may be closed from each other in normal times. When an inner pressure of the battery casing is increased to be greater than an outer pressure, the venting valve may be opened.

The battery casing may include a separate vent valve configured to be opened and closed to adjust the inner pressure of the battery casing in the normal times.

The plurality of longitudinal members and the plurality of transversal members may have heights lower than heights of the battery modules, thereby generating spaces above the plurality of longitudinal members and the plurality of transversal members.

According to the present disclosure, when off gas is generated in the battery pack, the battery pack is configured to quickly and efficiently emit the off gas to reduce or prevent chain of the thermal runaway of the battery cells in the battery pack, so that damage to the battery pack can be minimized in an emergency state.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a view showing a structure of a battery pack for a vehicle according to one embodiment of the present disclosure;

FIG. 2 is a view showing a state where the battery pack of FIG. 1 is mounted to a lower portion of the vehicle;

FIG. 3 is a view showing installation spaces of longitudinal members and transversal members in the battery casing, which are connected to each other to serve as a path through which gas is moved;

FIG. 4 is a sectional view taken along line IV-IV in FIG. 2;

FIG. 5 is a sectional view taken along line V-V in FIG. 2; and

FIG. 6 is a view showing a state where a venting valve is provided.

The drawings described herein are for illustration purposes only and are not intended to limit the scope of the present disclosure in any way.

### DETAILED DESCRIPTION

In the following description, the structural or functional description specified to exemplary embodiments according to the concept of the present disclosure is intended to describe the exemplary embodiments, so it should be understood that the present disclosure may be variously embodied, without being limited to the exemplary embodiments.

Embodiments described herein may be changed in various ways and various shapes, so specific embodiments are shown in the drawings and are described in detail in this specification. However, it should be understood that the exemplary embodiments according to the concept of the present disclosure are not limited to the embodiments which are described hereinbelow with reference to the accompanying drawings, but all of modifications, equivalents, and substitutions are included in the scope and spirit of the present disclosure.

It should be understood that, although the terms first and/or second, etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween. Further, the terms used herein to describe a relationship between elements, that is, “between”, “directly between”, “adjacent”, or “directly adjacent” should be interpreted in the same manner as those described above.

The terminology used herein is for the purpose of describing particular embodiments only and is not intended to limit the present disclosure. Singular forms are intended to include plural forms unless the context clearly indicates otherwise. It should be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

When a component, device, element, or the like of the present disclosure is described as having a purpose or performing an operation, function, or the like, the component, device, or element should be considered herein as being “configured to” meet that purpose or to perform that operation or function.

Unless otherwise defined, all terms including technical and scientific terms used herein have the same meaning as commonly understood by those having ordinary skill in the art to which the present disclosure belongs. It must be understood that the terms defined by the dictionary are identical with the meanings within the context of the related art, and they should not be ideally or excessively formally defined unless the context clearly dictates otherwise.

Hereinbelow, some embodiments are described hereafter in detail with reference to the accompanying drawings. Like reference numerals given in the drawings indicate like components.

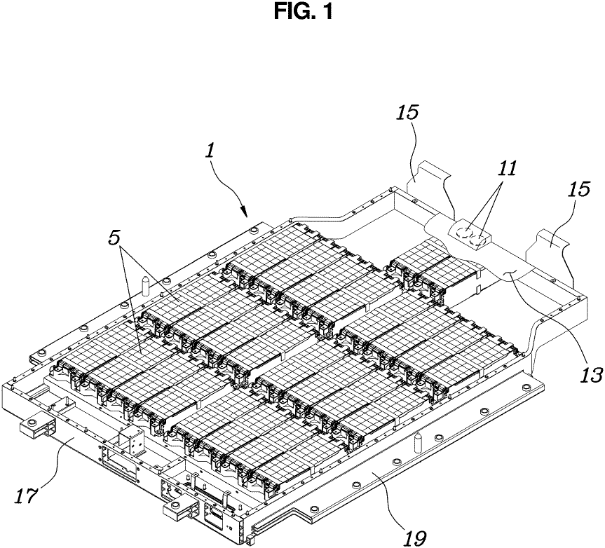

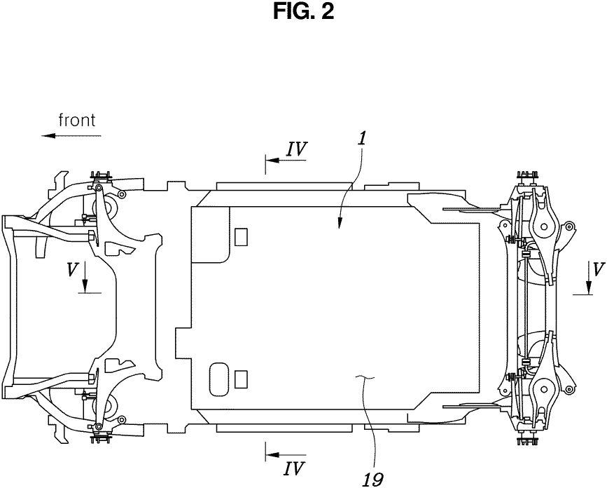

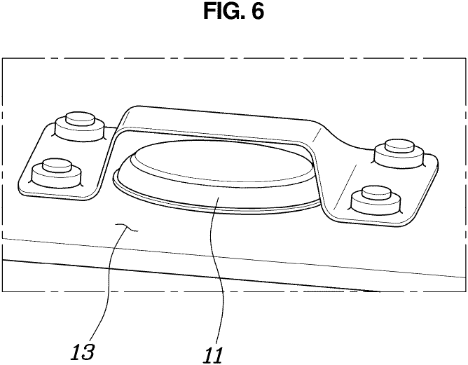

Referring to FIGS. 1 to 6, a battery pack 1 for a vehicle according to an embodiment of the present disclosure may include: a plurality of battery modules 5 arranged on a flat surface in a battery casing 3; a plurality of longitudinal members 7 and a plurality of transversal members 9 arranged between the plurality of battery modules 5; and a venting valve 11 provided at an upper portion of the battery casing 3. The venting valve 11 communicates with installation spaces of the plurality of longitudinal members 7 or the plurality of transversal members 9, and secures a discharge space for gas at an outside space of the battery casing 3.

In other words, the battery pack includes the venting valve 11 communicating with the installation spaces of the plurality of longitudinal members 7 and the plurality of transversal members 9 provided between the plurality of battery modules 5 arranged in the battery casing 3. Therefore, when off gas is discharged from an arbitrary battery cell in the battery casing 3, the battery pack of the present disclosure can perform quick and efficient discharge of the off gas through the venting valve 11.

The battery casing 3 includes a lower casing 19 at the lower side and an upper cover 13 at the upper side. The plurality of battery modules 5 is arranged on one flat surface in a space between the lower casing 19 and the upper cover 13.

For example, the plurality of longitudinal members 7 and the plurality of transversal members 9 have heights lower than heights of the plurality of battery modules 5. Therefore, spaces through which the off gas is movable are provided above the plurality of longitudinal members 7 and the plurality of transversal members 9.

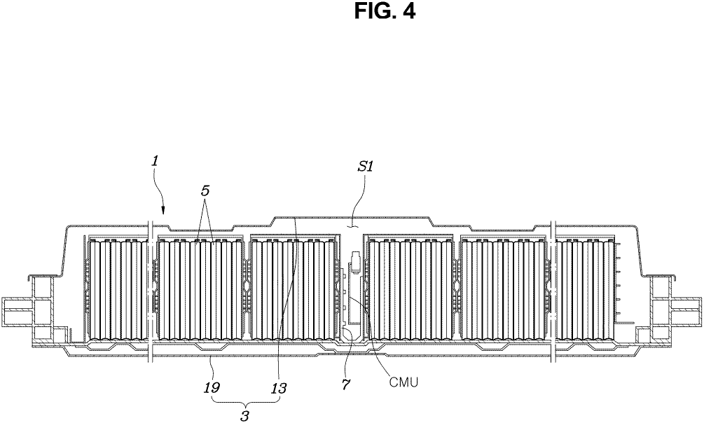

In other words, as shown in FIG. 4, the plurality of longitudinal members 7 is formed to have the height lower than the height of the plurality of battery modules 5. Although a cell monitoring unit (CMU) is provided in the battery casing, a space between the CMU and the plurality of longitudinal members 7 and spaces S1 between the plurality of longitudinal members 7 and the upper cover 13 are secured above the plurality of longitudinal members 7, so that the generated off gas may be moved through the space.

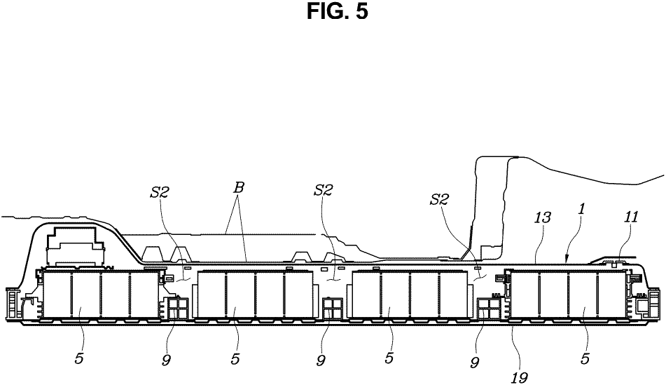

Furthermore, as shown in FIG. 5, the plurality of transversal members 9 is formed to have the height lower than the height of the plurality of battery modules 5, so that spaces S2 through which off gas is movable are secured above the plurality of transversal members 9.

Herein, the plurality of longitudinal members 7 is lengthily arranged in a longitudinal direction of the vehicle and the plurality of transversal members 9 is lengthily arranged in a transversal direction of the vehicle.

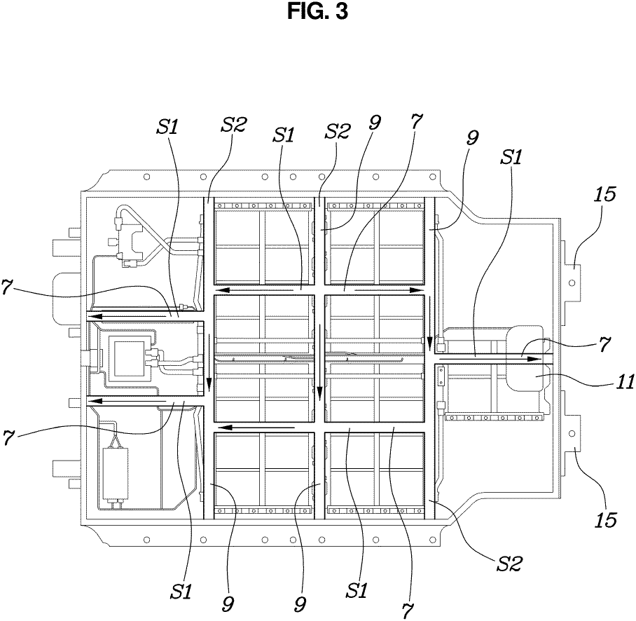

The installation spaces (S1, S2) formed by the plurality of longitudinal members 7 and the plurality of transversal members 9 may be arranged to form a grid shape through which the installation spaces communicate with each other on the flat surface formed by the plurality of battery modules 5, as shown in FIG. 3.

In other words, the installation spaces (S1, S2) of the plurality of longitudinal members 7 and the plurality of transversal members 9 are arranged to communicate with each other.

Therefore, when the off gas is discharged from an arbitrary battery cell in the battery casing 3, the off gas may be efficiently moved through the installation spaces (S1, S2) of the plurality of longitudinal members 7 and the plurality of transversal members 9. Thus, the off gas may be quickly and efficiently discharged through the venting valve 11 out of the battery casing 3. Therefore, it is possible to efficiently reduce or prevent thermal runaway generated by the off gas in the battery casing 3.

Among the installation spaces (S1) formed by the plurality of longitudinal members 7, one space extended rearward from the battery casing 3 is configured to communicate with the venting valve 11.

Furthermore, the venting valve 11 may be provided at an upper edge of the battery casing 3.

Generally, since a driver seat and a front passenger seat are located at a vehicle front portion of the battery casing 3, it is desired to secure a space for the feet of an occupant. However, it is difficult to easily secure a space to efficiently discharge the off gas discharged from the venting valve 11 at the upper portion of the battery casing 3. In order to communicate with the installation space of the plurality of longitudinal member 7 extended rearward from the battery casing 3, the venting valve 11 may be arranged at the rear upper edge of the battery casing 3 and thus efficiently discharges the off gas discharged from the venting valve 11 toward the rear of the vehicle.

A plurality of fixation brackets 15 may be mounted to a rear end of the battery casing 3 to fix the battery casing 3 to a vehicle body.

In the above case, the venting valve 11 is provided to communicate with at least one installation space among the installation spaces of the plurality of longitudinal members 7. In one form, the at least one space S1 is extended toward between the fixation brackets 15. (See, FIG. 3).

According to one embodiment, the fixation brackets 15 include two fixation brackets provided at opposite portions of the rear end of the battery casing 3. The venting valve 11 is provided to communicate one of the installation spaces of the plurality of longitudinal members 7, and the one space is extended toward a rear center portion of the battery casing 3, as shown in FIG. 3.

In other words, the venting valve 11 is provided to discharge the off gas into a space between the two fixation brackets 15.

Therefore, the off gas generated from an arbitrary battery cell in the battery casing 3 is moved through the installation spaces of the plurality of longitudinal members 7 and the plurality of transversal members 9 in the battery casing 3, and thus being efficiently discharged toward the rear of the vehicle through the venting valve 11.

Meanwhile, the venting valve 11 maintains a state where the inside space and the outside space of the battery casing 3 are closed from each other in normal times. When an inner pressure of the battery casing 3 is increases to be greater than an outer pressure, the venting valve 11 may be opened.

In the above case, the battery casing 3 includes a separate vent valve 17 that is opened or closed to adjust the inner pressure of the battery casing 3 in the normal times.

For example, the above normal times mean a situation where off gas is not emitted from a battery cell and all battery cells in the battery casing 3 are normally operated.

For example, a vehicle body panel B is also shown at above the battery pack in FIG. 5.

Although some embodiments of the present disclosure have been described for illustrative purposes, those of having ordinary skill in the art would appreciate that various modifications, additions and substitutions are possible, without departing from the scope and spirit of the present disclosure.

What is claimed is:

1. A battery pack for a vehicle, the battery pack comprising:
a plurality of battery modules arranged on a flat surface in a battery casing;
a plurality of longitudinal members and a plurality of transversal members arranged between the plurality of battery modules; and
a venting valve provided at an upper portion of the battery casing and configured to communicate with installation spaces formed by the plurality of longitudinal members or the plurality of transversal members, the venting valve configured to provide a discharge space for gas at an outside space of the battery casing.

2. The battery pack of claim 1, wherein the installation spaces of the plurality of longitudinal members and the plurality of transversal members are arranged to form a grid shape so that the installation spaces communicate with each other on the flat surface formed by the plurality of battery modules.

3. The battery pack of claim 1, wherein the installation spaces formed by the plurality of longitudinal members and the plurality of transversal members are configured to communicate with each other.

4. The battery pack of claim 3, wherein the venting valve is configured to communicate with one installation space of the installation spaces formed by the plurality of longitudinal members, and
wherein the one installation space is extended rearward from the battery casing.

5. The battery pack of claim 3, further comprising:
a plurality of fixation brackets mounted to a rear end of the battery casing to fix the battery casing to a vehicle body;
wherein the venting valve is configured to communicate with one installation space of the installation spaces formed by the plurality of longitudinal members, and the one installation space is extended toward a gap between the plurality of fixation brackets.

6. The battery pack of claim 5, wherein:
the plurality of fixation brackets comprises two fixation brackets provided at opposite portions of the rear end of the battery casing; and
the venting valve communicates with the one installation space of the installation spaces of the plurality of longitudinal members, and the one installation space is extended toward a rear center portion of the battery casing.

7. The battery pack of claim 1, wherein the venting valve is provided at an upper edge of the battery casing.

8. The battery pack of claim 1, wherein the venting valve is configured to maintain a state where an inside space and the outside space of the battery casing are closed from each other in normal times, and when an inner pressure of the battery casing is increased to be greater than an outer pressure, the venting valve is opened.

9. The battery pack of claim 8, wherein the battery casing comprises a separate vent valve configured to be opened and closed to adjust the inner pressure of the battery casing in the normal times.

10. The battery pack of claim 1, wherein the plurality of longitudinal members and the plurality of transversal members have heights lower than heights of the battery modules, thereby generating spaces above the plurality of longitudinal members and the plurality of transversal members.
